(19) United States
(12) Patent Application Publication
(10) Pub. No.: US 2009/0113015 A1
(43) Pub. Date: Apr. 30, 2009

(54) Remote Application Processing System

(76) Inventor: Timo Koster, Erlangen (DE)

Correspondence Address: BRINKS HOFER GILSON & LIONE, P.O. BOX 10395, CHICAGO, IL, 60610, US

(21) Appl. No.: 11/930,562

(22) Filed: Oct. 31, 2007

(51) Int. Cl. G06F 15/16

(52) U.S. Cl. 709/207

(57) ABSTRACT

A remote application processing system is provided. The remote application processing system includes one or more remote terminals; and a server operable to process an application for one or more remote terminals having a server service session. The server is operable to transmit a status change from the server to the one or more remote terminals having a server service session.

### BACKGROUND

The present embodiments relate to remote application processing systems. A remote application processing system includes a server on which a remote terminal session is running. The server stores and processes applications, programs and other resources which can be used via the remote terminal session. The server communicates user interface data to the remote terminal. The remote terminal displays the user interface data and transmits input data to the server. The input data is used by the application stored on or operating the server.

The server may support additional remote terminal service sessions. To communicate with the server, each remote terminal establishes and maintains a terminal service session. The remote terminal service sessions are connected to the server in parallel. The service sessions are independent of the other remote terminals. A server configuration change communicated from a remote terminal may be overridden by a subsequent or simultaneous change communicated from a different remote terminal.

The server generates and stores a session directory of the current service sessions, which are generated when a remote terminal connects to the server. The session directory is a database that tracks the service sessions that are actively running on the server. The session directory must be selected to view the connected terminal sessions.

### SUMMARY

The present embodiments relate to communicating, monitoring, or documenting changes to a server. In one embodiment, a client terminal is notified of a status change to a server. The status change may include activation and/or deactivation of a client terminal session. A client terminal session may include a communication connection from a client terminal to the server.

In one embodiment, one or more client terminals may connect to a chat session established by each client terminal session. The chat session may be used to communicate messages to the one or more client terminals connected to the chat session. The chat message history may be accessed by users that connect to the server via remote terminal sessions.

In one embodiment, a first client terminal may monitor information transmitted to or received from a second client terminal. The first client terminal may monitor the information anonymously.

In one embodiment, the server may generate a server diary that includes the changes made to the server configurations. The server diary includes a combination of all or a portion of the changes made by one or more client terminals. The server diary may be accessed by a user accessing the central server.

### BRIEF DESCRIPTION OF THE FIGURES

FIG. 1 shows one embodiment of a terminal service system.

FIG. 2 shows one embodiment of a server.

FIG. 3 shows one embodiment of a console.

FIG. 4 shows one embodiment of a client terminal.

FIGS. 5-9 are flow chart diagrams showing embodiments of methods for using terminal services.

### DETAILED DESCRIPTION

The present embodiments relate to a service (tool) used with Windows Server 2003 or other server application using RDP based on terminal services. The service may be automatically started in each session that becomes active by connecting to the server. The service is embedded in the system tray of a Windows Server Operating System in a Windows based system, but may be embedded in other locations.

The service may include a permanent monitor for terminal service sessions. All the terminal service sessions that become active/inactive are continuously monitored, so that a status change (e.g., active/inactive) may be detected. The status change may be transmitted to a user, in the form of a small status window that pops up directly above the system tray (similar to what happens when using Microsoft Outlook, when a new email message has been received). A history of the client terminal sessions connected to the server, the client terminal host name, the client terminal make address, IP address, time of the session, date of the session, and the duration of time of the session can also be viewed.

The service may include a chat service. The chat service can be initiated from an arbitrary session. The current chat course (string of message) can be viewed by any active session or any session that becomes active in the future, since the current chat session is running synchronously via all the sessions. Every user (regardless of who initiated the chat or regardless of a user's becoming active in the future) can join the chat course currently taking place simultaneously/synchronously. Access to the chat course (message string) is possible, by reading and/or writing, from all currently active sessions or sessions that will become active in the future. The current chat or chat history or chats already concluded in the past can be viewed. Other services may be provided.

The service may include monitoring other terminal sessions. One session can view 1 . . . N sessions. A window can be used to monitor a selected terminal session. The window displays the dynamic contents of the desired session, so that the further session can be observed (as if one were an owner of that session). The session 1 . . . N may be monitored anonymously, for example, in accordance with the “four-eyes” principle. The four-eyes principle allows one client terminal to monitor or view the information being sent to or from another client terminal. The information may be monitored or viewed without the other client terminal knowing that the one client terminal is viewing his actions.

The terminal service may include a session diary (machine diary). Any status change (active/inactive) is jointly logged automatically, permanently, and/or in a revision-proof way and capable of being reviewed at any time. Any configurations changes and/or keyboard inputs (e.g., key loggers) are jointly logged.

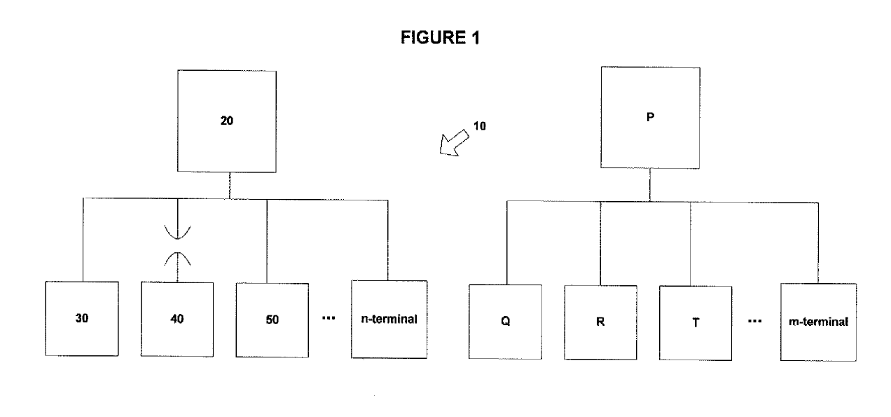

FIG. 1 shows a system 10 for remote application processing. The system 10 is a client-server architecture network, a thin client computing system, a remote application processing system, or other terminal service system or network. The system 10 allows one or more client terminals (30 . . . m-terminal) to access applications, programs, resources, and/or data stored on one or more servers (20 . . . P). For example, a client terminal 30 can access an application, such as Microsoft Windows, Microsoft Word, Microsoft Excel, UNIX, Macintosh OS, or Macintosh 3D Turbo, or other application running on the server 20. The application may be stored on the server 20. The server 20 processes the application and deploys the user interface data to the client terminal 30. The client terminal 30 controls the application as the application is processed on the server 20 by transmitting input data to the server 20.

The system 10 includes just a server 20 and a client terminal 30. Additional, different, or fewer components may be provided. For example, the system 10 may include additional client terminals (40, 50, . . . n-terminal). In another example, the system 10 includes one or more additional servers, such as server P. The system 10 may include additional client terminals, such as client terminals Q, R, T . . . m-terminal, connected to the one or more additional servers. In another example, the system 10 includes a remote second server.

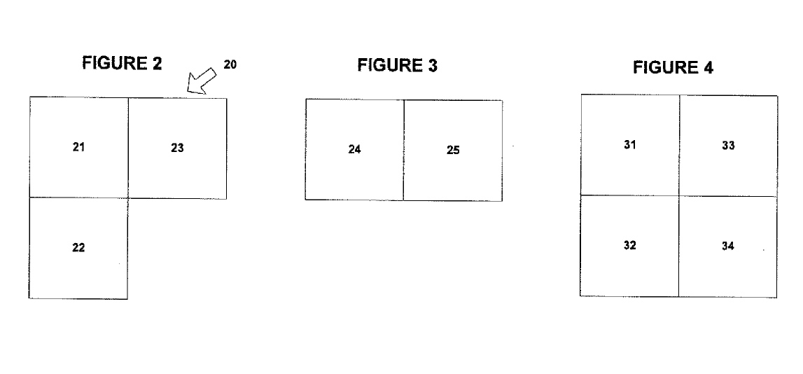

FIG. 2 shows one embodiment of the server 20. The server 20 is a terminal server, remote server, a central server, application server, a network access server, serial terminal server, a console server, a thin client server, or any server that provides computing for remote terminals. The server 20 works with the client terminals (30, 40, 50, . . . n-terminal). For example, the server 20 delivers application data or user interface data to the client terminals (30, 40, 50, . . . n-terminal). In another example, the server 20 receives input information from the client terminals (30, 40, 50, . . . n-terminal).

The server 20 communicates with the client terminals (30, 40, 50, . . . n-terminal) wirelessly, over a network, or using dedicated communication lines. For example, the server 20 may send and receive communications via a cable, wireless device, the Internet, a Web connection, or communication circuit. In another example, as shown in FIG. 1, the server 20 may be wirelessly connected to client terminal 40, but connected by wires to other terminals 30, 50, . . . n-terminal. Similar to the client terminals, the server 20 can communicate with other devices, such as the console 23 or the remote second server. For example, a communication circuit may be used to connect the console 23 to the server 20.

The server 20 may include a processor 21, a memory 22, and the console 23. Additional, different, or fewer components may be provided. For example, the server 20 may not include the console 23.

The processor 21 is a general processor, digital signal processor, application specific integrated circuit, field programmable gate array, analog circuit, digital circuit, combinations thereof or other now known, or later developed processor. The processor 21 may be a single device or a combination of devices, such as associated with a network or distributed processing. Any of various processing strategies may be used, such as multi-processing, multi-tasking, parallel processing or the like. The processor 21 is responsive to instructions stored as part of software, hardware, integrated circuits, firm-ware, micro-code, or the like. The processor 21 may be adjacent to, part of, networked with and/or remote from a storage medium, such as memory 22.

The processor 21 may communicate with the memory 22, the console 23, client terminals (30, 40, 50, . . . n-terminal), remote second server, or any combination thereof. The processor 21 may communicate with additional, fewer, or different devices. For example, the processor 21 may communicate with the display 34 of the client terminal 30. The processor 21 may communicate via a wireless device, dedicated communication line, network interface, communication circuit, or other communication device.

The processor 21 may read data stored in the memory 22. The readable data may include instructions, databases, images, driver information, client terminal information, session notifications, or other information. For example, the processor 21 may read operating system data, such as Microsoft Windows 2003 server data or other operation system data. In another example, the processor 21 reads instructions for a word processing application, such as Microsoft Word instructions.

The processor 21 may process readable data stored in the memory 22. The readable data may include instructions, databases, images, driver information, client terminal information, session notifications, or other information. For example, the processor 21 may boot and run operating system data stored in the memory 22. In another example, the processor 21 may analyze a text file. In another example, the processor 21 operates a set of instructions for performing a service. The processor 21 may process the readable data at any time interval, such as continuous processing or delayed interval processing. The processor 21 may process readable data in combination with processing other readable data. For example, the processor 21 may simultaneously process two applications.

The processor 21 may process one or more applications for remote terminals. For example, the processor may operate remote access programs, Microsoft Terminal Services, or other remote client programs. In another example, the processor 21 may load and operate an application, such as Microsoft Windows, UNIX, Macintosh OS, Microsoft Word, Microsoft Excel, Adobe Acrobat, Microsoft's Internet Explorer, Macintosh 3D Turbo, or other computer program.

The processor 21 may load a Remote Desktop Protocol (RDP) display device driver for a client terminal (30, 40, 50, . . . n-terminal). The RDP display device driver makes a client session available and interactive, remotely. In another example, the processor invokes a connection listener thread for a RDP protocol, which may listen for RDP client connections on a Transmission Control Protocol (TCP) port or User Datagram Protocol (UDP) port.

The processor 21 may receive and process information transmitted from one or more client terminals (30, 40, 50, . . . n-terminal). The information may include instructions, data, images, or other information for the server 20. For example, the processor 21 may process a response, inquiry, input, or other communication data transmitted from one or more client terminals (30, 40, 50, . . . n-terminal). The transmitted information may be used to control, operate or access one or more applications, operating systems, or data files stored on or accessible by the server 20. For example, the user may control an operating system being processed on the server 20. In another example, the user may select and load one or more applications stored on the server 20.

The processor 21 may transmit information to one or more client terminals (30, 40, 50, . . . n-terminal). The transmitted information may include application data, server data, display data, user interface data, monitoring data, chat message data, server diary information, notification data, data stored in the memory 22, client terminal information, image data, graphical interface data or other data stored on or communicated to the server 20. For example, the processor 21 may transmit data communicated from the console 23 or remote second server to the one or more client terminals (30, 40, 50, . . . n-terminal). In another example, the processor 21 transmits data, such as notification data, chat message data, monitoring data, or server diary data, to one or more client terminals (30, 40, 50, . . . n-terminal). In another example, the processor 21 transmits graphical interface data for an application, which is being processed by the processor 21, to the one or more client terminals (30, 40, 50, . . . n-terminal).

The processor 21 may operate Microsoft's Terminal Services or another remote application processing program. Microsoft's Terminal Services provides remote access to a client terminal (30, 40, 50, . . . n-terminal), such as a Windows desktop, through “thin client” software. Terminal Services allows the client terminal to serve as a terminal emulator. Terminal Services allows programs, such as Windows-based programs or other programs, to be distributed to remote client terminals (30, 40, 50, . . . n-terminal). Terminal Services provides a single point of installation with multiple client terminals having access to the processor 21. The client terminals (30, 40, 50, . . . n-terminal) can run programs, save files, and use network resources using the processor 21.

The processor 21 may identify a client terminal status change. The client terminal status change may include activation or deactivation of a client terminal's connection to the server 20. For example, the processor 21 may detect when a client terminal (30, 40, 50, . . . n-terminal) connects or disconnects to the server 20. In another example, the processor 21 identifies when a client terminal service session is established or destroyed. Alternatively, the client terminal status change may include a change to the server 20. For example, the client terminal status change may include the server 20 transmitting or receiving information from the client terminal (30, 40, 50, . . . n-terminal), such as when a message is transmitted to the server 20 from the client terminal 30. In another example, the client terminal status change may include any change or alteration related to a client terminal (30, 40, 50, . . . n-terminal).

The processor 21 may generate a notification when a status change is identified. The notification may include an identification, location, text, audio, message, graphic, photograph, image, or any combination thereof. The identification may include, for example, a host name, IP address, time of status change, duration of time, or other client terminal or status change information. For example, the notification may include the user's name operating the client terminal (30, 40, 50, . . . n-terminal) that connects to the server 20. In another example, the notification includes a client terminal location. In another example, the notification includes the identified status change. In another example, the notification includes a photograph of the user. In another example, the notification includes the user's name and photograph.

The processor 21 may transmit the notification to one or more client terminals (30, 40, 50, . . . n-terminal). The notification may be transmitted to all or a portion of the client terminals (30, 40, 50, . . . n-terminal). For example, the notification may be transmitted to only the client terminals (30, 40, 50, . . . n-terminal) that have currently established service sessions. In another example, the processor 21 transmits the connected to all of the client terminals (30, 40, 50, . . . n-terminal).

The processor 21 may generate a pop-up notification. The pop-up notification may include notification that pops up on the client terminal (30, 40, 50, . . . n-terminal). For example, if client terminal 40 connects to the server 20, the connected client terminal 30 receives a notification, which pops up on the display 33, informing the user of client terminal 30 that client terminal 40 is connected to client terminal 20. In another example, the pop up notification may pop up from the system tray of the client terminal (30, 40, 50, . . . n-terminal).

The processor 21 may display the pop-up notification on the client terminal (30, 40, 50, . . . n-terminal). The pop-up notification may be displayed for any length of time. For example, the pop-up notification may remain displayed for a period of time and then disappear. In another example, the pop-up notification may be displayed until closed by a user, such as an advertisement when browsing the Internet. In another example, the pop-up notification may remain displayed for as long as the client terminal service session is maintained.

The notification may be disposed in the system tray of the display 33. For example, if client terminals 30, 40 and 50 are connected to the server 20, the permanent identification may include the numbers “40” and “50” displayed in the system tray of client terminal 30. The notification may include other identifiers, such as photographs, names, icons, pictures, words, letters, or any identifier. Alternatively, the system tray may include a shortcut to a list of active sessions. The list of active sessions may be used to identify the client terminals connected to the server 20.

The processor 21 may generate a chat session between one or more client terminals (30, 40, 50, . . . n-terminal). The chat session may include a chat room for conferencing, such as synchronous and asynchronous conferencing. The chat session is a real-time chat between active client terminal sessions on the server 20. For example, the chat session is similar to instant messaging between the active sessions. Alternatively, the chat session may be a graphical social environment. The one or more client terminals (30, 40, 50, . . . n-terminal) may use the chat session to communicate messages to other client terminals (30, 40, 50, . . . n-terminal) in the same chat session in real-time. For example, the chat session may include a message board (e.g., text field), which client terminals can post messages to during the chat session. The chat session may be used to deliver data from one client terminal to another client terminal. The chat session may be used to transmit text, audio, or images. For example, the chat session may communicate information input from a client terminal (30, 40, 50, . . . n-terminal). In another example, the processor 21 may transmit information, such as a configuration change, to the one or more client terminals (30, 40, 50, . . . n-terminal) in the chat session by posting a message on the message board. The chat session is running on server 20. Only client terminals with an active terminal session connected to the server 20 may use the chat session.

The processor 21 may transmit the chat session history to the memory 22 for storage. The chat session history may include the messages communicated during the chat session. The chat session history may be used to review the communication from one client terminal to the other client terminals. The chat session history may also include the configuration changes to the server 20 or other server 20 information generated, changed, or deleted during the chat session. A user that connects to the server 20 after the chat session has been established may be view the chat session history.

A user that connects to a chat session may see past, present, and future chat session messages. The user may view the messages communicated from the client terminals (30, 40, 50, . . . n-terminal) before the user connected to the server 20. For example, the client terminal 30 may connect to the server 20 and establish a chat session. The client terminal 30 may begin transmitting messages in the chat session, such as “changed config. B” and “changed config. Z.” At a subsequent time, the client terminal 40 connects to the server 20 by establishing a service session. The client terminal 40 joins, either automatically or by selection, the chat session established by the client terminal 30. The client terminal 40 transmits “Hi, user of client terminal 30” in the chat session. The client terminal 40 may review the past messages that the client terminal 30 transmitted before the client terminal 40 joined the chat session and the messages transmitted after he joined the chat session. For example, the client terminal 40 will display “changed configuration B”; “changed configuration Z”; and “Hello, user of client terminal 30.” The client terminal 40 will also be able to see future messages transmitted in the chat session. In another example, the client terminals 30 and 40 connect to the server 20 and establish a chat session. The client terminals 30, 40 communicate messages using the chat session. The client terminal 50 subsequently joins the chat session and is able to view the previous messages transmitted between the client terminals 30 and 40. The client terminal 50 is able to begin communicating messages to the other client terminals 30, 40.

The processor 21 may transmit monitoring data to one or more client terminals (30, 40, 50, . . . n-terminal). The monitoring data may include information being communicated to one or more client terminals (30, 40, 50, . . . n-terminal). The monitoring data may be a copy or replica of the information being communicated to a client terminal (30, 40, 50, . . . n-terminal). For example, the processor 21 may copy the information transmitted to one client terminal 40, and transmit the copied information, which is the monitoring data, to another client terminal 30. The monitoring data may be transmitted anonymously. For example, the one client terminal 40 may not know that the other client terminal 30 is viewing the information being communicated to the one client terminal 40.

The monitoring data may be transmitted in real-time. For example, as the information is being transmitted from the server 20 to the client terminal 40, a copy of the same information is being transmitted to the other client terminal 30. Alternatively, the monitoring data may be stored and viewed at a subsequent time. For example, an IT administrator may review information transmitted to one or more client terminals (30, 40, 50, . . . n-terminal) at a time when the one or more client terminals (30, 40, 50, . . . n-terminal) are not connected to the server.

The processor 21 may operate to generate a server diary. The server diary may be a database including server configuration changes, client terminal service session information, changes made to the server 20 during a client terminal session, user information, client terminal information, server 20 information, time-related information, or other information related to the client terminal sessions. For example, the server diary may be generated or altered each time a client terminal (30, 40, 50, . . . n-terminal) service session is established or disconnected. In another example, the server diary includes a server configuration change, such as a virus removal procedure, a server password change procedure, or other procedure that changes a server configuration. The configuration change may include any change of operation system or special application configuration files, for example, changes to database tables, XML files, or registry files.

The memory 22 is computer readable storage media. Computer readable storage media includes various types of volatile and non-volatile storage media, including but not limited to random access memory, read-only memory, programmable read-only memory, electrically programmable read-only memory, electrically erasable read-only memory, flash memory, magnetic tape or disk, optical media and the like. The memory 22 may be a single device or a combination of devices. The memory 22 may be adjacent to, part of, networked with and/or remote from the processor 21.

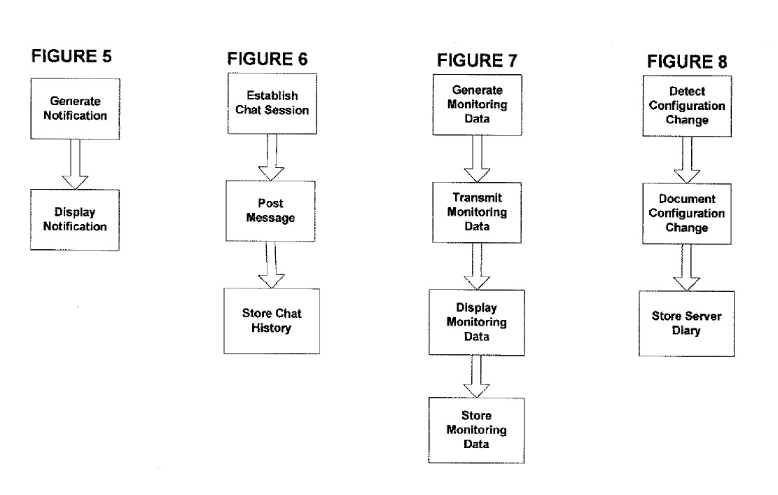

The memory 22 may store instructions for remote access programs. For example, the memory 22 may store instructions for Microsoft's Terminal Services. In another example, the memory 22 stores instructions as shown in FIGS. 5-8. In another example, the memory 22 may store instructions for displaying a notification on one or more client terminals (30, 40, 50, . . . n-terminal) when the status of one or more client terminals (30, 40, 50, . . . n-terminal) changes. In another example, the memory may store instructions for generating a chat session for one or more client terminals (30, 40, 50, . . . n-terminal). The instructions include transmitting a message to the chat session. The message may be viewed by the client terminals (30, 40, 50, . . . n-terminal) in the chat session. In another example, the memory 22 may store instructions for monitoring the information transmitted to or received from one or more client terminals (30, 40, 50, . . . n-terminal), In another example, the memory 22 may store instructions for generating a server diary that includes changes made to the server 20.

The memory 22 may store information. The stored information may include databases, charts, images, text files, photographs, indexes, audio files, or any combination thereof. The stored information may include more, less, or different information. For example, the memory 22 may include client terminal information, such as client terminal locations, user information, or other information related to the client terminal. In another example, the memory 22 includes a list client service sessions. The list of client service sessions may be accessed to identify the client terminals connected to the server 20. In another example, the memory 22 includes the host name, IP address, service session time, duration of the service session, or other information relating to the service session.

FIG. 3 shows one embodiment of the console 23. The console 23 is a server console, terminal service console, IT administrator workstation, local server console, remote server console, or other server interactive device. The console 23 is used to monitor and interact with the server 20. For example, the console 23 may be connected directly to the server 20. Alternatively, the console 23 is remote from the server 20.

The console 23 may include a display 24 and an input device 25. Additional, different, or fewer components may be provided. For example, the console 23 includes more than one display 24 and/or more than one input device 25. The console 23 interacts with the server 20. For example, an IT administrator may use the console 23 to add, subtract, or change configurations, files, or applications in the server 20. The console 23 is a combination of readouts, displays, and/or input devices.

The console 23 may establish a console session with the server 20. The console session allows the console 23 to interact with the server 20. For example, the appropriate drivers, such as the display, mouse, and keyboard drivers, are loaded when the console session is established.

The display 24 is a CRT, monitor, flat panel, LCD, projector, printer, or other now known or later developed display device for outputting determined information. The processor 21 may cause the display 24 to display information, data, or images. For example, the display 24 may display server 20 configurations, server 20 information, client terminal (30, 40, 50, . . . n-terminal) information, console session information, client terminal session information, application output data, application input data, system 10 information, or other information related to the system 10, server 20, or client terminal (30, 40, 50, . . . n-terminal).

The input device 25 may be a keyboard, switch, computer mouse, touchpad, read/write drive, CD-RW drive, DVD-RW drive, touch-screen, or other device for inputting commands. The input device 25 inputs commands, instructions, results, or data to the processor 21 or memory 22. For example, the input device 25 may be a computer mouse that is used to select a default configuration for the server 20. In another example, the input device 25 is a keyboard that inputs client specific information, such as a user name, client terminal location, restriction codes, passwords, network information, or other system 10 information. In another example, the input device 25 is a read/write drive that is used to install instructions in the memory 22 of the server 20.

FIG. 4 shows one embodiment of a client terminal 30. The client terminal 30 is a remote terminal, personal computer, desktop computer, laptop computer, notebook computer, personal mobile device, thin client, lean client, diskless node, thick client, hybrid client, workstation, network computer, remote desktop connection device, remote desktop snap-in, remote desktop web connection device, or other remote terminal. The client terminal 30 connects to and works with the server 20. For example, the client terminal 30 depends on the server 20 for processing activities and conveys input and output between the user and the remote server 20. In another example, the client terminal 30 processes some activities and depends on the server 20 for processing other activities.

The client terminal 30 may include a processor 31, memory 32, input device 33, and display device 34. Additional, different, or fewer components may be provided. For example, the client terminal 30 may include multiple input devices. Although FIG. 4 illustrates client terminal 30, the other client terminals (40, 50, . . . n-terminal) may include the same, additional, fewer, or different components. For example, the client terminals (40, 50, . . . n-terminal) may be different personal computers with different operating systems. In another example, the client terminals have different input devices. In another example, all of the client terminals have the same components.

The processor 31 is a general processor, digital signal processor, application specific integrated circuit, field programmable gate array, analog circuit, digital circuit, combinations thereof or other now known, or later developed processor. The processor 31 may be a single device or a combination of devices, such as associated with a network or distributed processing. Any of various processing strategies may be used, such as multi-processing, multi-tasking, parallel processing or the like. The processor 31 is responsive to instructions stored as part of software, hardware, integrated circuits, firm-ware, micro-code, or the like. The processor 31 may be adjacent to, part of, networked with and/or remote from a storage medium, such as memory 32.

The processor 31 may communicate with the memory 32, the input device 33, the display 34, or the server 20. The processor 31 may communicate with additional, fewer, or different devices. The processor 21 may communicate via a wireless device, dedicated communication line, communication circuit, or other communication device.

The processor 31 may read instructions stored on the memory 32. For example, the processor 31 may read instructions that establish and maintain a service session between the client terminal 30 and the server 20. In another example, the processor 31 reads application instructions stored on the memory 32. The application instructions may include computer programs or applications. Alternatively, the processor 31 may read instructions stored on memory 22 of the server 20.

The processor 31 may process the readable instructions. For example, the processor 31 may establish and maintain a client terminal service session between the client terminal 30 and the server 20. In another example, the processor 31 may process the computer program or application stored in the memory 32.

The processor 31 may operate and process multiple instructions, programs, or applications at the same time. For example, the processor 31 may operate to maintain a client terminal service session while processing an application or program stored on the memory 32. In a first screen display, such as a window, the client terminal 30 may display an application being processed on the server 20, and on a second screen display, the client terminal 30 may display an application being processed on the client terminal 30. Alternatively, the processor 31 may process more than one set of instructions stored in memory 22 and/or in memory 32.

The processor 21 may detect, recognize, or locate client terminal information. For example, the client terminal information may include the client terminal address, communication port information, protocol information, information about the user operating the client terminal, the time of day that the client terminal information is detected, or other information relating to the client terminal connection.

The processor 21 may retrieve information related to the client terminal (30, 40, 50, . . . n-terminal) that attempts to establish or establishes a connection to the server 20. For example, the processor 21 may access client terminal information stored in memory 22. The client terminal information may include a client terminal address, session ID, user name, user photograph, user resume, user security code, other information related to the client terminal (30, 40, 50, . . . n-terminal) that changes status of the service session.

The memory 32 is computer readable storage media. Computer readable storage media includes various types of volatile and non-volatile storage media, including but not limited to random access memory, read-only memory, programmable read-only memory, electrically programmable read-only memory, electrically erasable read-only memory, flash memory, magnetic tape or disk, optical media and the like. The memory 32 may be a single device or a combination of devices. The memory 32 may be adjacent to, part of, networked with and/or remote from the processor 31.

The memory 32 may store instructions. The instructions may be readable by the processor 31. For example, the memory 32 may store an application that establishes and maintains the service session between a client terminal (30, 40, 50, . . . n-terminal) and the server 20. In another example, the memory 32 stores instructions for an application or program, such as Microsoft Windows, Macintosh OS X, Microsoft Word, UNIX, or Macintosh Safari. The memory 32 may also store information communicated from the server 20 or for communication to the server 20.

The input device 33 may be a keyboard, switch, computer mouse, touchpad, read/write drive, CD-RW drive, DVD-RW drive, touch-screen, or other device for inputting commands. The input device 33 inputs commands, instructions, results, or data to the processor 31, memory 32, or server 20. For example, the input device 33 may be device for communicating with the server 20. In another example, the input device 33 is a keyboard that inputs client specific information, such as a user name, client terminal location, restriction codes, passwords, network information, or other system 10 information. In another example, the input device 33 is a read/write drive that is used to install instructions in the memory 32.

The display 34 is a CRT, monitor, flat panel, LCD, projector, printer, or other now known or later developed display device for outputting determined information. The processor 31 or processor 21 may cause the display 34 to display information, data, or images. For example, the display 34 may display server 20 configurations, server 20 information, client terminal (30, 40, 50, . . . n-terminal) information, console session information, client terminal session information, notification data, chat message data, monitoring data, server diary data, application output data, application input data, system 10 information, or other information related to the system 10, server 20, or client terminal (30, 40, 50, . . . n-terminal).

The system 10 may include a remote second server. The remote second server may be used to provide remote services to the system 10. For example, the client terminal 30 may be connected to server 20 via the second server. In another example, the client terminal is connected directly to the server 20, which is connected to the remote second server.

FIG. 5 shows a flow chart of a method for providing notification of a status change to one or more client terminals (30, 40, 50, . . . n-terminal). The method is implemented using the system 10 of FIG. 1 or a different system. The method may be used independent from, in combination with, or as a portion of a remote access program, such as Microsoft's Terminal Services. The acts are performed in the order shown (or described) or a different order. The acts may be performed automatically, manually, or combinations thereof.

The method in FIG. 5 may include generating a notification and transmitting the notification to one or more client terminals (30, 40, 50, . . . n-terminal) connected to the server 20. Additional, different or fewer acts than shown in FIG. 5 may be provided.

In act 510, a notification is generated. Generating a notification may include identifying a server status change, and generating a notification defined by the status change. Additional, different or fewer acts may be provided.

Identifying a server status change may include detecting when a client terminal (30, 40, 50, . . . n-terminal) establishes a client service session, detecting when a client service session is disconnected, or detecting when the server receives or transmits client terminal information. In one embodiment, the server 20 may identify a status change when a client terminal (30, 40, 50, . . . n-terminal) establishes or attempts to establish a service session with the server 20. For example, the server 20 may identify a status change when client terminal 30 establishes a service session with the server 20 by running client software stored on the memory 32. In another embodiment, the server 20 may identify a status change when a client service session is disconnected. In another embodiment, a status change may be identified when information is transmitted to or received from the server 20. In another embodiment, a status change may be triggered by a change made to the system 10 that is relevant to the client terminals (30, 40, 50, . . . n-terminal).

The server 20 may generate a notification defined by the status change. Generating the notification may include combining relevant information. For example, the notification data may include information that identifies a client terminal (30, 40, 50, . . . , n-terminal). In another example, the notification includes a client terminal 30 address detected by the server 20 and a user name retrieved by the server 20. In another example, the notification includes the information relevant to the client terminal that triggered the status change. In another example, the notification a description of a change made to a server configuration.

In act 520, the notification data is displayed on one or more client terminals (30, 40, 50, . . . n-terminal) connected to the server 20. Displaying notification data may include identifying the client terminals (30, 40, 50, . . . n-terminal) connected to the server 20, transmitting the notification data to the client terminals (30, 40, 50, . . . n-terminal) connected to the server 20, and displaying a notification including the notification data on the one or more client terminals (30, 40, 50, . . . n-terminal) connected to the server 20. Additional, different or fewer acts may be provided.

The server 20 may identify the active client terminals (30, 40, 50, . . . n-terminal). The active client terminals (30, 40, 50, . . . n-terminal) are the client terminals connected to the server 20. Identifying the client terminals (30, 40, 50, . . . n-terminal) connected to the server 20 may include detecting active client sessions, reading an active client session report that lists the client terminals that are active, or using other active client recognition methods.

The server 20 may transmit the notification data to the active client terminals (30, 40, 50, . . . n-terminal). For example, the processor 21 may transmit the notification data to the active client terminals. Alternatively, the server 20 may transmit the notification data to all or a portion of the client terminals (30, 40, 50, . . . n-terminal), including active and non-active terminals.

The server 20 may display the notification on the one or more client terminals (30, 40, 50, . . . n-terminal) connected to the server 20. For example, the processor 21 may operate to display a notification on the display 33 of client terminal 30. In another example, if client terminal 40 establishes a service session with server 20, the processor 21 may operate to display a notification, which identifies that client terminal 40 is now an active client terminal, on the display 33 of active client terminal 33. If other client terminals (50 . . . n-terminal) are active, the server 20 would operate to display the notification on the displays of the active terminals.

The server 20 may display the notification as a pop-up message. The pop-up message may be displayed for a short interval and then disappear. The pop-up message may pop up from the system tray. For example, the pop-up message may be similar to receiving an email message in Microsoft Outlook. The processor 21 may update a client session history report to indicate that the client terminal 40 is now active. The client session history may be available in a toolbar on the display 33. The client session history lists the active client terminals. The client session history may be used to send messages to one or more client terminals, for example, by selecting the desired client terminal.

FIG. 6 shows a method for chatting using one or more client terminals (30, 40, 50, . . . n-terminal) connected to a server 20. The method is implemented using the system 10 of FIG. 1 or a different system. The method may be used independent from, in combination with, or as a portion of a remote access program, such as Microsoft's Terminal Services. The acts are performed in the order shown (or described) or a different order. The acts may be performed automatically, manually, or combinations thereof.

The method shown in FIG. 6 may include, establishing a chat session and posting a message in the chat session. Additional, different or fewer acts than shown in FIG. 6 may be provided. For example, in act 630, a chat history is stored.

In act 610, the server 20 establishes a chat session between one or more client terminals (30, 40, 50, . . . n-terminal). Establishing the chat session may include forming a chat room. The chat room may include a message board that is visible to each client terminal (30, 40, 50, . . . n-terminal) connected to the chat session. The message board may include messages input by the client terminals (30, 40, 50, . . . n-terminal), messages generated by the server 20, or other messages. The messages may include identification, such as the name of the user that input the message, the time of input, or other information related to the message. For example, if client terminal 30 transmits “I changed configuration XYZ.” to the message board of the chat session, the message board may display: “Client Terminal 30: I changed configuration XYZ (date and time).”

In act 620, one or more client terminals (30, 40, 50, . . . n-terminal) post messages in the chat room. Posting a message may include generating a chat message, transmitting the message to the client terminals in the chat session, and displaying the message.

A chat message may be generated. A user may generate a message by inputting a message, for example, using the input device 34. As discussed above, a user may input “I changed configuration XYZ” as a message. Alternatively, the server 20 may generate a message based on changes performed by the client terminals (30, 40, 50, . . . n-terminal). For example, if client terminal 30 instructs the server 20 to change a configuration, the server 20 may generate a message that states: “Client terminal changed XYZ.” The message may include a description of the specific change.

The chat message may be transmitted to the server 20. For example, if the client terminal 30 generates a message, the message may be transmitted to the server 20.

The server 20 displays the chat message in a chat session on each of the client terminals (30, 40, 50, . . . n-terminal) connected in the chat session. The chat message may be displayed on the message board. The message board may include a string of messages. The messages may be ordered chronologically, by user name, or any other ordering.

Client terminals (30, 40, 50, . . . n-terminal) may join the chat session after the chat session has been established. For example, if client terminal 30 establishes a chat session, client terminal 40 may join the chat session at a later time. Client terminal 40 may view the messages that were posted to the message board before client terminal 40 joined the chat session.

In act 630, a chat history is stored. The chat history may include a list of the messages, identification, and/or other chat session information, such as the time that the chat session was established or terminated. The chat history may be stored in memory 22 or on a disc. The chat history may be accessed by the one or more client terminals (30, 40, 50, . . . n-terminal).

FIG. 7 shows a method for monitoring one or more client terminals (30, 40, 50, . . . n-terminal). The method is implemented using the system 10 of FIG. 1 or a different system. Additional, different or fewer acts than shown in FIG. 7 may be provided. The method may be used independent from, in combination with, or as a portion of a remote access program, such as Microsoft's Terminal Services. The acts are performed in the order shown (or described) or a different order. The acts may be performed automatically, manually, or combinations thereof.

The method of FIG. 7 may include generating monitoring data, transmitting the monitoring data to one or more client terminals (30, 40, 50, . . . n-terminal), and displaying the monitoring data on one or more client terminals. Additional, different or fewer acts may be provided. For example, in act 740 the monitoring data may be stored.

In act 710, monitoring data is generated. Generating monitoring data may include detecting and copying information transmitted to or received from one or more client terminals (30, 40, 50, . . . n-terminal). For example, monitoring data may include user interface information transmitted from the server 20 to the client terminal 30. In another example, monitoring data may include the input information transmitted from the client terminal 30 to the server 20.

In act 720, the server 20 transmits the monitoring data to one or more client terminals (30, 40, 50, . . . n-terminal). The server 20 may send the monitoring information to all or a portion of the client terminals (30, 40, 50, . . . n-terminal). The server 20 may limit the transmission of monitoring data based on an access right, security of the transmission line, or other monitoring consideration. For example, the console 23 may have an access right to monitor any of the client terminals (30, 40, 50, . . . n-terminal). In another example, one client terminal 30 may only have an access right to monitor a specific other client terminal 40.

In act 730, the monitoring information is displayed on one or more client terminals (30, 40, 50, . . . n-terminal). For example, the monitoring information may be displayed in a separate window on the display 33 of the client terminal 30. In another example, if client terminal 30 is monitoring client terminal 40, the monitoring information may be used to generate a display replica of client terminal 40's display.

The monitoring information may be transmitted anonymously. For example, if one client terminal 30 is monitoring another client terminal 40, the monitoring information being transmitted to and/or received from the other client terminal 40 may be transmitted to the one client terminal 30 without the other client terminal 40 knowing that the one client terminal 30 is receiving the monitoring information.

In act 740, the monitoring information may be stored in memory 22. The monitoring information may be displayed in real-time or stored in memory 22 and displayed at a later time. For example, the server 20 may generate monitoring information for each of the client terminals (30, 40, 50, . . . n-terminal) and store it in memory 22. The IT administrator may access and view the monitoring information for any of the client terminals (30, 40, 50, . . . n-terminal) at a later time using the console 23.

FIG. 8 shows a method for documenting changes made to the server 20 by one or more client terminals (30, 40, 50, . . . n-terminal). The method is implemented using the system 10 of FIG. 1 or a different system. Additional, different or fewer acts than shown in FIG. 8 may be provided. The method may be used independent from, in combination with, or as a portion of a remote access program, such as Microsoift's Terminal Services. The acts are performed in the order shown (or described) or a different order. The acts may be performed automatically, manually, or combinations thereof.

The method shown in FIG. 8 may include detecting a configuration change to the server 20 and documenting the configuration change in a server diary. Additional, different or fewer acts may be provided. For example, in act 830, the documented changes may be stored.

In act 810, the server 20 may detect a configuration change to the server 20. The configuration change may include any change to the server 20. For example, the configuration change may include saving a file, cleaning a virus, changing a password, or any other deviation to server 20. The configuration change may be made by the client terminals (30, 40, 50, . . . n-terminal), the console 23, the remote second server, or any other device connected to the server 20.

In act 820, the configuration changes may be documented in the server diary. The server diary may be a list of events, changes, transactions, or observations kept at a time interval. The time of change, the name of the user instructing the change, or other configuration change information may be recorded in the server diary. The server diary may include information not-related to the configuration change. For example, the server diary may be combined with the session directory. In another example, the server diary may include information about the server 20. The server diary may be stored in the memory 22. A user may access the server diary. For example, a user may operate client terminal 30 to access the server diary stored in memory 22.

In act 830, the configuration change information may be stored in memory 22. The configuration change information may be displayed in real-time or stored in memory 22 and displayed at a later time. For example, the server 20 may generate configuration change information when a client terminal (30, 40, 50, . . . n-terminal) changes a configuration and stores the configuration change information in the memory 22. The IT administrator may access and view the configuration change information for any of the client terminals (30, 40, 50, . . . n-terminal) at a later time using the console 23.

Various embodiments described herein can be used alone or in combination with one another. For example, the methods shown in FIGS. 5-8 may be combined using any combination. The forgoing detailed description has described only a few of the many possible implementations of the present invention. For this reason, this detailed description is intended by way of illustration, and not by way of limitation. It is only the following claims, including all equivalents that are intended to define the scope of this invention.

1. A method for notifying one or more remote terminals connected to a server when a status change is detected, the method comprising:
generating a notification when the status change is detected, and
displaying the notification on one or more remote terminals having a service session with the server.

2. The method as claimed in claim 1, wherein the status change includes a change in a service session status.

3. The method as claimed in claim 2, wherein the change in the service session status includes the service session becoming activated or inactivated.

4. The method as claimed in claim 1, wherein displaying the notification includes transmitting the notification from the server to the one or more remote terminals connected to the server

5. The method as claimed in claim 1, wherein displaying the notification includes displaying the notification as a pop-up notification.

6. A method for communicating a message to one or more remote terminals having a remote service session with a remote application server; the method comprising:
establishing a chat session with one or more remote terminals;
transmitting a message to a message board that is viewable by the remote terminals connected to the chat session; and
displaying the message on the message board.

7. The method according to claim 6, wherein the chat session may run on the remote application server.

8. The method according to claim 6, wherein transmitting the message may include transmitting from the server.

9. The method according to claim 6, wherein transmitting the message may include transmitting the message from a remote terminal connected to the chat session.

10. The method according to claim 6, wherein displaying the message on the message board includes displaying one or more previous messages on the message board to remote terminals that connect to the chat session at a subsequent time.

11. The method according to claim 6, wherein the message may include a change to a server configuration.

12. The method according to claim 11, wherein transmitting includes transmitting from the remote application server.

13. A remote application processing system, the system comprising:
one or more remote terminals; and
a server operable to process an application for one or more remote terminals having a server service session;
wherein the server is operable to transmit a status change from the server to the one or more remote terminals having a server service session.

14. The remote application system as claimed in claim 13, wherein the status change includes a change to an activation status of the one or more remote terminals having a server service session.

15. The remote application system as claimed in claim 13, wherein the server is operable to detect the status change.

16. The remote application system as claimed in claim 13, wherein the server is operable to display a notification defined by the status change on the one or more remote terminals having the server service session.

17. The remote application system as claimed in claim 13, wherein the status change is monitoring data.

18. A remote application processing system, the system comprising:
one or more remote terminals; and
a server operable to process an application for one or more remote terminals having an active server service session;
wherein the server is operable to establish a chat session for the one or more remote terminals connected to the server, the chat session being used to display one or more messages on the one or more remote terminals having the active server service session.

19. The remote application system as claimed in claim 18 wherein the message includes an instant message.

20. The remote application system as claimed in claim 19, wherein the chat message is transmitted from the client terminal to the server.

21. In a computer readable storage media having stored therein data representing instructions executable by a programmed processor for use of communicating a status change to one or more remote terminals, the storage media comprising instructions for:
identifying a status change; and
displaying the status change on one or more remote terminals having an active remote service session.

22. The computer readable storage media as claimed in claim 21, wherein identifying a status change includes identifying when an activation status of the one or more remote terminals changes.

23. The computer readable storage media as claimed in claim 22, wherein displaying the status change includes displaying a notification when activation status of the one or more remote terminals changes.

24. The computer readable storage media as claimed in claim 21, wherein displaying the status change includes displaying a chat message for a chat session running on the server for one or more active client terminal service sessions.

25. The computer readable storage media as claimed in claim 21, wherein identifying the status change includes identifying a server configuration change that may be listed in a server diary.
